(19) United States
(12) Patent Application Publication
(10) Pub. No.: US 2008/0020875 A1
(43) Pub. Date: Jan. 24, 2008

(54) ACCESSORY DRIVE SYSTEM

(76) Inventors: Richard K. Serrels (Deceased), Otisville, MI (US); Peter J. Savagian, Bloomfield Hills, MI (US); Matthew D. Laba, Troy, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/459,375

(22) Filed: Jul. 24, 2006

(51) Int. Cl. F16H 61/00; F16H 7/12

(52) U.S. Cl. 474/70; 474/135

(57) ABSTRACT

The apparatus of the present invention is adapted to supply power to one or more of the belt driven accessories of a hybrid electro-mechanical vehicle while the engine is off. Additionally, the power may be provided to multiple accessories with a single electric motor thereby saving the cost associated with manufacturing and installing a separate electric motor for each accessory. The apparatus includes an electric motor, a motor clutch, an engine clutch, and an accessory drive belt. When the engine is on, the accessory drive belt transfers torque from the engine crank shaft to the belt driven accessories. When the engine is off, the accessory drive belt transfers torque from the electric motor to the belt driven accessories.

### TECHNICAL FIELD

The present invention is drawn to a system configured to drive electronic accessories on a vehicle.

### BACKGROUND OF THE INVENTION

The electronic accessories in a conventional motor vehicle are powered by output from the engine. A hybrid electro-mechanical vehicle generally includes both an internal combustion engine and one or more electric motor/generators. Some of the electronic accessories in a hybrid vehicle may require power while the engine is off and the vehicle is being powered by the electric motor/generator. Traditionally, in order to power hybrid vehicle accessories when the engine is off, it was necessary to provide each such accessory with a separate electric motor.

### SUMMARY OF THE INVENTION

The apparatus of the present invention is adapted to supply power to one or more of the belt driven accessories of a hybrid electro-mechanical vehicle while the engine is off. Advantageously, the power may be provided to multiple accessories with a single electric motor thereby saving the cost associated with manufacturing and installing a separate electric motor for each accessory. The belt driven accessories may include, for example, power steering; air conditioning compressors; water pumps; cooling fans; etc.

The apparatus includes an electric motor, a motor clutch, an engine clutch, and an accessory drive belt. When the engine is on, the accessory drive belt transfers torque from the engine crank shaft to the belt driven accessories. When the engine is off, the accessory drive belt transfers torque from the electric motor to the belt driven accessories.

The motor clutch is configured to transmit torque from the electric motor to the accessory drive belt when the engine is off, and to spin freely without transmitting torque (i.e., freewheel) when the engine is on. Accordingly, when the engine is driving the accessory drive belt, the electric motor is effectively removed from the system by the motor clutch such that the system is operational without incurring the efficiency loss attributable to backdriving the electric motor. Additionally, by decoupling the electric motor from the system when the engine is operating, the electric motor is not required to spin at the maximum engine speed which is advantageous because a more durable and expensive electric motor would otherwise be required.

The engine clutch is configured to transmit torque from the internal combustion engine to the accessory drive belt when the engine is on, and to freewheel when the engine is off. Accordingly, when the engine is off it is effectively removed from the system by the engine clutch such that the system is operational without incurring the efficiency loss attributable to backdriving the engine.

According to one aspect of the invention, the accessory drive system includes a plurality of transfer pulleys each adapted to transfer rotational motion from the accessory drive belt to one of the vehicle accessories.

According to yet another aspect of the invention, the accessory drive system includes a plurality of tension pulleys adapted to maintain tension in the accessory drive belt such that energy is transferable through the accessory drive belt in an efficient manner.

According to yet another aspect of the invention, the accessory drive system includes an engine clutch pulley attached to the engine clutch and configured to facilitate the transfer of energy from the engine to the accessory drive belt.

According to still another aspect of the invention, the accessory drive system includes a motor clutch pulley attached to the motor clutch and configured to facilitate the transfer of energy from the electric motor to the accessory drive belt.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic depiction of a hybrid electro-mechanical vehicle having an accessory drive system in accordance with the present invention; and

FIG. 2 is a schematic depiction of the accessory drive system of FIG. 1;

### DESCRIPTION OF THE PREFERRED EMBODIMENTS

The apparatus of the present invention is adapted to supply power to one or more of the belt driven accessories of a hybrid electro-mechanical vehicle while the engine is off. The belt driven accessories may include, for example, power steering; air conditioning compressors; water pumps; cooling fans; etc.

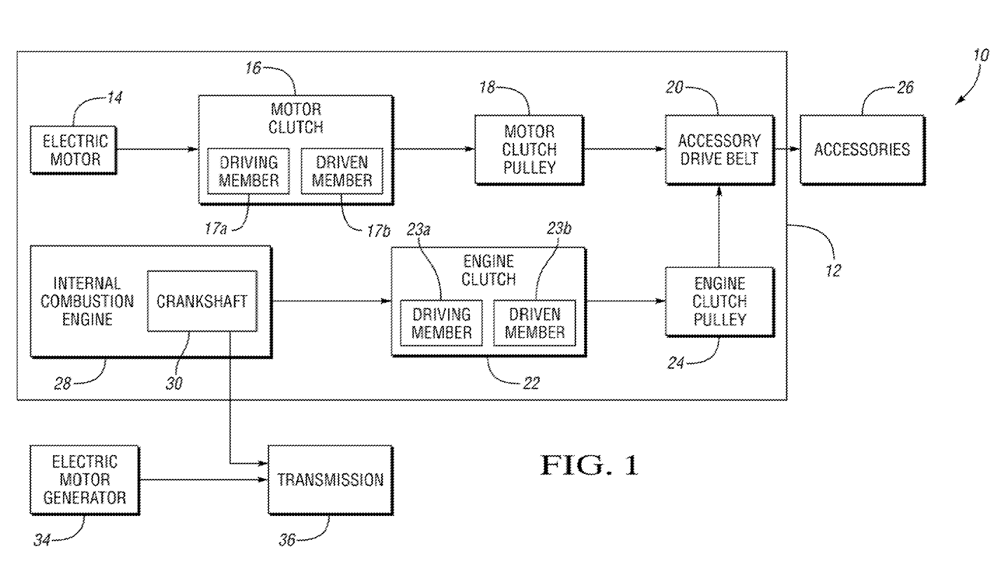

Referring to FIG. 1, a hybrid electro-mechanical vehicle 10 including an accessory drive system 12 is shown. The accessory drive system 12 preferably includes an electric motor 14, a motor clutch 16, a motor clutch pulley 18, an accessory drive belt 20, an engine clutch 22, and an engine clutch pulley 24. The accessory drive belt 20 is connected to the belt driven accessories 26 such that power is transferable thereto. The accessory drive system 12 also preferably includes an internal combustion engine 28 having a crank shaft 30.

The hybrid vehicle 10 is configured to optimize fuel economy by selectively operating either the engine 28 or an electric motor/generator 34 to supply the power to a transmission 36 and operate the vehicle 10. The accessory drive system 12 of the present invention allows the accessories 26 to be driven by the engine 28 when the engine 28 is on, and by the motor 14 when the engine 28 is off as will be described in detail hereinafter. In this manner, the accessories 26 are operational even when the hybrid vehicle 10 is being powered by the electric motor/generator 34 and the engine 28 is off. Additionally, power may be provided by multiple accessories with a single electric motor thereby saving the cost associated with manufacturing and installing a separate electric motor for each accessory.

According to a preferred embodiment of the present invention, the motor clutch 16 and the engine clutch 22 are over-running one-way clutches. It should be appreciated, however, that over-running one-way clutches are merely a preferred embodiment and that alternate clutch configurations may implemented for the clutches 16 and 22 as well. The motor clutch 16 includes a driving member 17a connected to the electric motor 14, and a driven member 17b connected to the motor clutch pulley 18. The engine clutch 22 includes a driving member 23a connected to the crank shaft 30, and a driven member 23b connected to the engine clutch pulley 24. Optionally, the engine clutch 22 may include a damper system such as a harmonic balancer (not shown). As is known in the art, a “harmonic balancer” is a device adapted to reduce the transmission of resonant frequencies and protect the engine 28.

As is known in the art, an over-running one-way clutch transmits torque based on the relative speed across the clutch, wherein the relative speed across the clutch is defined as the speed of the driving member versus the speed of the driven member. As an example, the motor clutch 16 may be configured to transmit torque if the speed of the driving member 17a is greater than the speed of the driven member 17b, and not to transmit torque (or freewheel) if the speed of the driven member 17b is greater than the speed of the driving member 17a. Similarly, the engine clutch 22 may be configured to transmit torque if the speed of the driving member 23a is greater than the speed of the driven member 23b, and not to transmit torque (or freewheel) if the speed of the driven member 23b is greater than the speed of the driving member 23a. Accordingly, when the engine 28 is off, the speed of the driving member 23a is zero and the engine clutch 22 will freewheel as the system 12 is powered by the electric motor 14 such that power is supplied to the accessories 26 without backdriving the engine 28.

When the engine 28 is on, the accessory drive system 12 is configured to transfer torque from the engine 28, through the crank shaft 30; the engine clutch 22; the engine clutch pulley 24; the accessory drive belt 20; and to the accessories 26. According to a preferred embodiment, when the engine 28 is on the motor clutch 16 freewheels to effectively remove the electric motor 14 from the accessory drive system 12 such that the system 12 is operational without incurring the efficiency loss attributable to spinning the electric motor 14. Additionally, by decoupling the electric motor 14 from the accessory drive system 12 when the engine 28 is operating, the electric motor 14 is not required to spin at the maximum engine speed which is advantageous because a more durable and expensive electric motor would otherwise be required.

When the engine 28 is off, the accessory drive system 12 is configured to transfer torque from the motor 14, through the motor clutch 16; the motor clutch pulley 18; the accessory drive belt 20 and to the accessories 26. In this manner, the accessories 26 may be powered by the motor 14 when the hybrid vehicle 10 is being powered by the electric motor/generator 34 and the engine 28 is off. According to a preferred embodiment, when the engine 28 is off the engine clutch 22 freewheels to effectively remove the engine 28 from the accessory drive system 12 such that the system 12 is operational without incurring the efficiency loss attributable to spinning the crank shaft 30.

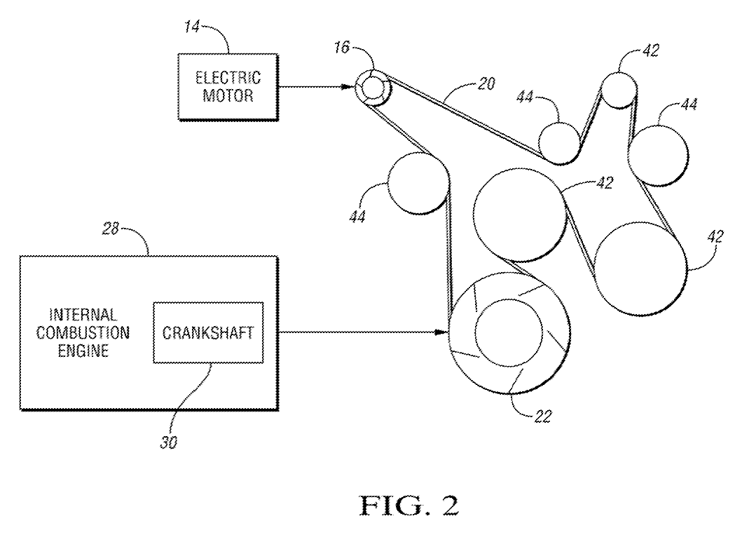

Referring to FIG. 2, a schematic depiction of a preferred embodiment of the present invention is shown. The crank shaft 30 of the internal combustion engine 28 transfers torque to the driving member 23a (shown in FIG. 1) of the engine clutch 22. The electric motor 14 transfers torque to the driving member 17a (shown in FIG. 1) of the motor clutch 16. A plurality of transfer pulleys 42 are each adapted to transfer rotational motion from the accessory drive belt 20 to one of the accessories 26 (shown in FIG. 1). Alternatively, the accessories 26 may be connected directly to the accessory drive belt 20 without implementing the transfer pulleys 42. A plurality of tension pulleys 44 are preferably implemented to maintain tension in the accessory drive belt 20 so that power is transferable in an efficient manner. It should be appreciated that while the embodiment shown in FIG. 2 is preferred, alternate embodiments may be envisioned such as, for example, embodiments having different quantities of pulleys and/or accessory drive belts, different accessory drive belt configurations, and/or different pulley configurations.

While the best modes for carrying out the invention have been described in detail, those familiar with the art to which this invention relates will recognize various alternative designs and embodiments for practicing the invention within the scope of the appended claims.

1. A drive system adapted to power one or more vehicle accessories comprising:
a motor configured to generate power for said one or more accessories;
an accessory drive belt operatively connected with said motor, said accessory drive belt configured to transfer the power generated by the motor to said one or more accessories; and
a motor clutch operatively connected with said motor and said accessory drive belt, said motor clutch configured to selectively couple the motor to the accessory drive belt such that power is transferable from the motor to the accessories, said motor clutch further being configured to selectively decouple the motor from the accessory drive belt such that the accessory drive belt may be driven by an alternate power source without incurring an efficiency loss attributable to backdriving the motor.

2. The drive system of claim 1 further comprising an engine clutch configured to selectively couple an engine to the accessory drive belt such that power is transferable from the engine to the accessories, said engine clutch further being configured to selectively decouple the engine from the accessory drive belt such that the accessory drive belt may be driven by the motor without incurring an efficiency loss attributable to backdriving the engine.

3. The drive system of claim 2 further comprising a plurality of transfer pulleys operatively connected with said accessory drive belt and said accessories, said plurality of transfer pulleys each adapted to transfer rotational motion from the accessory drive belt to one of the vehicle accessories.

4. The drive system of claim 3 further comprising a plurality of tension pulleys operatively connected with said accessory drive belt, said plurality of tension pulleys adapted to maintain tension is said accessory drive belt such that energy is transferable through the accessory drive belt in an efficient manner.

5. The drive system of claim 4 further comprising a motor clutch pulley attached to the motor clutch, said motor clutch pulley configured to facilitate the transfer of energy from the motor to the accessory drive belt.

6. The drive system of claim 5 further comprising an engine clutch pulley attached to the engine clutch, said engine clutch pulley configured to facilitate the transfer of energy from the engine to the accessory drive belt.

7. A drive system adapted to power one or more vehicle accessories comprising:
a motor configured to generate power for said one or more accessories;
an accessory drive belt operatively connected with said motor, said accessory drive belt configured to transfer the power generated by the motor to said one or more accessories;
a motor clutch operatively connected with said motor and said accessory drive belt, said motor clutch configured to selectively couple the motor to the accessory drive belt such that power is transferable from the motor to the accessories, said motor clutch further being configured to selectively decouple the motor from the accessory drive belt such that the accessory drive belt may be driven by an alternate power source without incurring an efficiency loss attributable to backdriving the motor; and
an engine clutch in communication with an engine and said accessory drive belt, said engine clutch configured to selectively couple the engine to the accessory drive belt such that power is transferable from the engine to the accessories, said engine clutch further being configured to selectively decouple the engine from the accessory drive belt such that the accessories may be driven by the motor without incurring an efficiency loss attributable to backdriving the engine.

8. The drive system of claim 7, further comprising a plurality of transfer pulleys operatively connected with said accessory drive belt and said accessories, said plurality of transfer pulleys each adapted to transfer rotational motion from the accessory drive belt to one of the vehicle accessories.

9. The drive system of claim 8, further comprising a plurality of tension pulleys operatively connected with said accessory drive belt, said plurality of tension pulleys adapted to maintain tension is said accessory drive belt such that energy is transferable through the accessory drive belt in an efficient manner.

10. The drive system of claim 9, further comprising a motor clutch pulley attached to the motor clutch, said motor clutch pulley configured to facilitate the transfer of energy from the motor to the accessory drive belt.

11. The drive system of claim 10, further comprising an engine clutch pulley attached to the engine clutch, said engine clutch pulley configured to facilitate the transfer of energy from the engine to the accessory drive belt.

12. A drive system adapted to power one or more vehicle accessories comprising:
a motor configured to generate power for said one or more accessories;
an accessory drive belt operatively connected with the motor, said accessory drive belt configured to transfer the power generated by the motor to said one or more accessories;
a motor clutch operatively connected with said motor and said accessory drive belt, said motor clutch configured to selectively couple the motor to the accessory drive belt such that power is transferable from the motor to the accessories, said motor clutch further being configured to selectively decouple the motor from the accessory drive belt such that the accessories may be driven by an alternate power source without incurring an efficiency loss attributable to backdriving the motor.
an engine clutch in communication with an engine and said accessory drive belt, said engine clutch configured to selectively couple the engine to the accessory drive belt such that power is transferable from the engine to the accessories, said engine clutch further being configured to selectively decouple the engine from the accessory drive belt such that the accessory drive belt may be driven by the motor without incurring an efficiency loss attributable to backdriving the engine;
a motor clutch pulley attached to the motor clutch, said motor clutch pulley configured to facilitate the transfer of energy from the motor to the accessory drive belt; and
an engine clutch pulley attached to the engine clutch, said engine clutch pulley configured to facilitate the transfer of energy from the engine to the accessory drive belt.

13. The drive system of claim 12, further comprising a plurality of transfer pulleys operatively connected with said accessory drive belt and said accessories, said plurality of transfer pulleys each adapted to transfer rotational motion from the accessory drive belt to one of the vehicle accessories.

14. The drive system of claim 13, further comprising a plurality of tension pulleys operatively connected with said accessory drive belt, said plurality of tension pulleys adapted to maintain tension is said accessory drive belt such that energy is transferable through the accessory drive belt in an efficient manner.
